(19) United States
(12) Patent Application Publication
(10) Pub. No.: US 2026/0074509 A1
(43) Pub. Date: Mar. 12, 2026

(54) HIGH-SPEED HIGH-SENSITIVITY TRANSFORMER DIFFERENTIAL PROTECTION USING ENHANCED RESTRAINING TECHNIQUES

(71) Applicant: Schweitzer Engineering Laboratories, Inc., Pullman, WA (US)

(72) Inventors: Bogdan Z. Kasztenny, Markham (CA); Satish Samineni, Malvern, PA (US)

(73) Assignee: Schweitzer Engineering Laboratories, Inc., Pullman, WA (US)

(21) Appl. No.: 19/305,922

(22) Filed: Aug. 21, 2025

Related U.S. Application Data
(60) Provisional application No. 63/693,580, filed on Sep. 11, 2024.

(51) Int. Cl. H02H 7/045; H02H 1/00

(52) U.S. Cl. CPC H02H 7/045; H02H 1/0007

(57) ABSTRACT

Transformer differential protection notwithstanding magnetizing inrush and overexcitation conditions is disclosed herein. Differential protection uses differential and restraining signals calculated using compensated winding currents. The protection is effective during magnetizing inrush and overexcitation conditions by determining whether the differential current is due to the magnetizing inrush or overexcitation. Further, the protection may determine a fault condition during energization.

### RELATED APPLICATIONS

This application claims priority from and benefit of U.S. Provisional Application Ser. No. 63/693,580 filed on 11 Sep. 2024 entitled “Transformer Differential Protection” which is hereby incorporated by reference in its entirety for all purposes.

### TECHNICAL FIELD

This disclosure relates to transformer differential protection notwithstanding magnetizing inrush and overexcitation conditions. More specifically, this disclosure relates to transformer differential protection that rules out magnetizing inrush and overexcitation as sources of differential current to enhance the speed of operation, and rules out current transformer and transformer ratio errors as sources of differential current to enhance sensitivity.

### BRIEF DESCRIPTION OF THE DRAWINGS

Non-limiting and non-exhaustive embodiments of the disclosure are described, including various embodiments of the disclosure with reference to the figures, in which:

FIG. 1 illustrates a simplified one-line diagram of an electric power delivery system comprising an Intelligent Electronic Device (IED) implementing transformer differential protection in accordance with several embodiments herein.

FIG. 2 illustrates a simplified logic diagram to determine an internal fault of a transformer using transformer differential protection in accordance with several embodiments herein.

FIG. 3 illustrates a simplified logic diagram of a transformer differential element in accordance with several embodiments herein.

FIG. 4 illustrates a connection diagram of a delta-wye-connected transformer in accordance with several embodiments herein.

FIGS. 5A-5D illustrate plots of percentage restraint functions for transformer differential protection.

FIG. 6A illustrates a logic diagram for calculating a restraint signal for transformer differential protection.

FIG. 6B illustrates a logic diagram for calculating a restraint signal for transformer differential protection in accordance with several embodiments herein.

FIG. 6C illustrates a logic diagram for calculating a restraint signal for transformer differential protection in accordance with several embodiments herein.

FIG. 7 illustrates a simplified one-line diagram of a portion of an electric power delivery system including a sample transformer in accordance with several embodiments herein.

FIG. 8 illustrates a sample plot of differential current during sympathetic inrush conditions in accordance with several embodiments herein.

FIG. 9 illustrates a sample plot of voltage flux during a switching event in accordance with several embodiments herein.

FIG. 10 illustrates sample plots of transformer differential current during energization for faulted and inrush conditions in accordance with several embodiments herein.

In the following description, numerous specific details are provided for a thorough understanding of the various embodiments disclosed herein. However, those skilled in the art will recognize that the systems and methods disclosed herein can be practiced without one or more of the specific details, or with other methods, components, materials, etc. In addition, in some cases, well-known structures, materials, or operations may not be shown or described in detail in order to avoid obscuring aspects of the disclosure. Furthermore, the described features, structures, or characteristics may be combined in any suitable manner in one or more alternative embodiments.

### DETAILED DESCRIPTION

Electric power delivery systems generally comprise equipment and devices for the generation, voltage-level transformation, transmission, distribution, and consumption of electric power. Such systems are typically monitored and protected by IEDs that obtain electrical measurements such as voltage and current from the power system and use those measurements to determine a condition of the power system. IEDs may effect a protective action (such as signaling a circuit breaker to trip) under certain determined conditions. For example, an IED may include a differential protection element that uses signals obtained from the electric power delivery system to determine a fault condition based on the differential principle. If the fault is detected within the differential zone the IED may signal a circuit breaker to trip.

Power transformers are expensive assets with long lead times and complicated onsite delivery and installation steps. Transformer faults may result in limited damage, allowing the transformer to be repaired, or in a catastrophic failure, resulting not only in scrapping the damaged transformer but also in a substation fire with collateral damage and environmental costs due to the potential for an oil spill. The speed and sensitivity of an IED protecting the transformer (such as a transformer protective relay) can be the difference between a routine trip and extensive, costly damage.

Transformer differential protection follows the operating principles devised many decades ago within the limitations of the electromechanical relay technology. This backward compatibility and intentionally restrained innovation contributed to the fast adoption of microprocessor-based differential protection IEDs but resulted in no or only limited protection performance improvements. Prior transformer differential protection elements take a power cycle or more to operate, have limited sensitivity to turn faults, and may face both security and dependability problems during transformer energization.

The present disclosure addresses the speed and sensitivity of transformer differential protection. Magnetizing inrush current is a critical obstacle to the transformer differential protection speed: having to rule out inrush slows down the transformer differential protection to about 1.5 electric power system cycles. Current transformer (CT) ratio errors and the onload tap changer operation are key obstacles to the differential element sensitivity.

The disclosure describes novel approaches for ruling out magnetizing inrush as the cause of the differential current, offering an opportunity to reduce the transformer differential protection operating time to about a quarter cycle. Magnetizing inrush that is ruled out as a cause of differential current (thus allowing the differential element to operate) includes, for example, voltage recovery inrush current (clearance of a nearby external fault) and sympathetic inrush current (an energized transformer drawing a gradually increasing inrush current because of dc offset in the voltage that is caused by the initial energization of a nearby transformer).

Transformer differential protection is based on an ampere-turn balance between pairs of legs of the transformer core. Therefore, it can detect changes in the ampere-turns, including 1) current diverted away from any part of any winding and 2) an effective change in turns of any winding. These two scenarios cover turn-to-turn faults, interwinding faults, and winding-to-ground faults. Transformer differential protection covers all fault types, although with varying and sometimes limited sensitivity.

Restricted earth fault (REF) protection monitors Kirchhoff's current balance between the currents at the winding terminals and the grounded neutral of a wye- or zigzag-connected winding. Therefore, it protects a winding (not the entire transformer) and is only able to detect ground terminal faults and winding-to-ground faults. REF protection has limited coverage compared with transformer differential protection, but its application is beneficial because it is more sensitive to ground faults close to the winding neutral point. Also, REF protection security is not affected by the transformer magnetizing current.

Current differential protection is the strongest protection principle at our disposal. However, when applied to a specific power apparatus, it faces specific security challenges. In the case of a power transformer, it is the magnetizing current that demonstrates itself as a spurious differential current and causes security issues. Additionally, tap changers (onload or offline) vary the turns ratio of a transformer, upset the nominal ampere-turn balance, and by doing so cause a spurious differential current to appear.

Following are sources of spurious differential current:
Transformer magnetizing current. The ampere-turn balance equations that underpin the transformer differential protection do not account for the magnetizing current, and therefore the magnetizing current demonstrates itself as a spurious differential current. Accordingly, magnetizing inrush current must be ruled out as an actionable cause of the differential current. Categories of magnetizing current include, for example: initial energization inrush current; voltage recovery inrush current; sympathetic inrush current; sudden voltage change inrush current; and, overexcitation (overvoltage and/or underfrequency) current. Traditionally, harmonic blocking or restraining are used to secure the transformer differential element during magnetizing current conditions.
CT ratio errors. A transformer differential current comprises three or more measured currents. When using breaker bushing CTs in dual-breaker applications, more than five measured currents may be used to make up the transformer differential current. Each of these currents is measured with a small CT ratio error. These errors can partially cancel or accumulate and yield a small standing differential current. Previously, a minimum pickup threshold and a small percentage restraint (e.g., 15 percent of the transformer nominal current) address the CT ratio errors in transformer differential elements.
Transformer ratio. The ampere-turn balance equations that establish the transformer differential protection assume numbers of turns that correspond to nominal winding voltages. In reality, the transformer voltage ratio has a finite tolerance due to flux variations near the winding edges and proximity effects. A small difference in the transformer ratio demonstrates itself as a small standing differential current. Previously, a small percentage restraint addresses the transformer ratio error in the transformer differential elements. A tap changer further exacerbates this problem by contributing to ratio changes on the order of 10 percent.
CT saturation during external faults. When CTs saturate during external faults, the CT errors increase far beyond small ratio errors. CT errors elevate the spurious differential current considerably during external faults. The transformer impedance limits the external fault current to about 10 times the nominal current, and by doing so, it alleviates the danger of severe CT saturation during through-faults. However, in dual-breaker applications, the transformer impedance does not limit the current passing through the two breakers (in and out of the transformer differential zone if using breaker bushing CTs, but without passing through the transformer itself). In these cases, the through-fault current can be very high. Also, in systems with large reactance/resistance (X/R) ratios, the slowly decaying dc component in the fault current can cause CT saturation even if the transformer impedance limits the AC component in the external fault current.

The long-lasting DC component in the initial energization inrush current also causes CT saturation. External faults immediately following transformer energization may cause the transformer CTs to saturate because the preceding inrush current elevates the CT flux.

Previously, transformer differential protection elements use a high percentage restraint to address CT saturation. A transformer differential element can apply such increased restraint permanently, or it can engage a high restraint when it detects an external fault by using an external fault detection logic.

External faults that do not produce zero-sequence current (phase-to-phase and balanced three-phase faults) but cause CT saturation may affect REF protection security. Traditionally, the REF element balances the neutral-point winding current with the tripled zero-sequence current (310) at the winding terminals. The 310 component in the secondary currents is spurious during phase faults with CT saturation. As a remedy to this problem, REF elements often require the presence of the neutral-point current before they operate (the neutral-point current is zero during external phase faults).

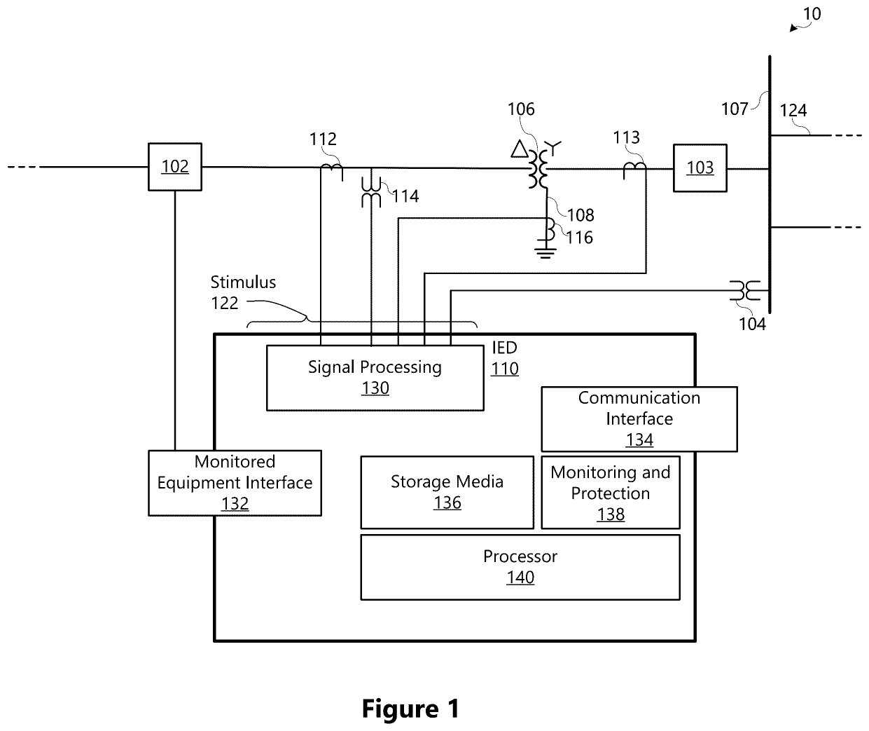

FIG. 1 illustrates a simplified one-line diagram of an electric power delivery system 10 that includes a transformer 106 (as illustrated in delta-wye configuration) and an IED 110 for providing protection to the transformer 106 including transformer differential protection in accordance with several embodiments herein.

The illustrated portion of the electric power delivery system includes a delta-wye-connected transformer 106, circuit breakers 102, 103 that may be used to isolate the transformer 106, bus 107 between the transformer 106 and the transmission lines (e.g. 124). Current transformer (CT) 112 on the delta side of the transformer 106 may provide secondary signals related to the current in each phase at the terminals on one side of the transformer 106. Similarly, CT 113 on the wye-side of the transformer 106 may provide secondary signals related to the current in each phase at the terminals on a second side of the transformer 106. Voltage transformers (VT) 104, 114 may provide signals related to the voltages of each phase on each side of the transformer 106. The transformer 106 may step up the voltage of the electric power from the generator from a generator (low-side) level to a transmission (high-side) level. A CT 116 may be placed in electrical communication with a neutral connection 108 of the wye-side of the transformer 106 and may provide to the IED 110 signals related to the neutral-point current.

The IED 110 provides protection to the transformer 106 of the electric power delivery system protection including, as discussed herein, transformer differential protection. The illustrated IED 110 includes a processor 140 for executing computer instructions, which may comprise one or more general purpose processors, special purposes processors, application-specific integrated circuits, programmable logic elements (e.g., FPGAs), or the like. The IED 110 may further comprise non-transitory machine-readable storage media 136, which may include one or more disks, solid-state storage (e. g., Flash memory), optical media, or the like for storing computer instructions, measurements, settings and the like. In various embodiments the storage media 136 may be packaged with the processor 140, separate from the processor 140, or there may be multiple physical storage media 136 including media packaged with the processor 140 and media 136 separate from the processor 140.

The IED 110 may be communicatively coupled to other IEDs and/or supervisory systems either directly or using one or more communication networks via one or more communication interfaces 134. In some embodiments, the IED 110 may include human-machine interface (HMI) components (not shown), such as a display, input devices, and so on.

The IED 110 may include a plurality of monitoring and protection elements, described as a monitoring and protection module 138 that may be embodied as instructions stored on computer-readable media (such as storage media 136). The instructions, when executed on the processor 140, cause the IED to detect a fault and may also cause the IED to execute a protective action in response to the detected fault (e.g. signaling a circuit breakers 102, 103 to open the appropriate phases), display fault information, send messages including the fault information, and the like. Methods disclosed herein may generally follow the instructions stored on media for system protection.

The monitoring and protection module 138 may include protection elements such as, for example, transformer differential protection, REF protection, and the like. The storage media 136 may include protective action instructions to cause the IED 110 to signal a circuit breakers 102, 103 to open via the monitored equipment interface 132 upon detection of a fault condition (path to circuit breaker is not separately illustrated).

The IED 110 may obtain electrical signals (the stimulus 122) from the power system 10 through instrument transformers (CTs, PTs, or the like). The stimulus 122 may be received directly via the measurement devices described above and/or indirectly via the communication interface 134 (e.g., from another IED or other monitoring device (not shown) such as a merging unit of the electrical power system 10). The stimulus 122 may include, but is not limited to: current measurements, voltage measurements, equipment status (breaker open/closed) and the like.

The IED includes a signal processing module 130 to receive the electric power system signals and process the signals for monitoring and protection such as differential protection. Line currents and voltages are sampled at a rate suitable for protection, such as in the order of kHz to MHz. An analog-to-digital converter (ADC) may be included to create digital representations of the incoming line current and voltage measurements. The output of the ADC may be made available to the processor 140 and used in various embodiments herein. As illustrated, the signal processing 130 receives analog signals from instrument transformers in electrical communication with equipment of an electric power delivery system, and processes those signal for use in the processor 140.

Although not separately illustrated, in various embodiments the IED 110 may receive digitized analog signals from external units such as merging units that receive analog power system signals and transmit the digitized analog signals to the IED. These digitized analog signals may be processed by the signal processing module 130 for use by the processor 140.

A monitored equipment interface 132 may be in electrical communication with monitored equipment such as circuit breakers 102, 103. Circuit breakers 102, 103 are configured to selectively trip (open) upon receipt of a trip command from the IED 110. The monitored equipment interface 132 may include hardware for providing a signal to the circuit breakers 102, 103 to open and/or close. In its backup capacity, the IED 110 may be configured to detect a fault and to determine a protective action and effect the protective action on the power system by, for example, signaling the monitored equipment interface 132 to provide an open signal to the appropriate circuit breakers 102, 103. Upon detection of the fault, the IED 110 may signal other devices (using, for example, the network, or signaling another device directly by using inputs and outputs) regarding the fault, which other devices may signal a breaker to open, thus effecting the protective action on the electric power delivery system.

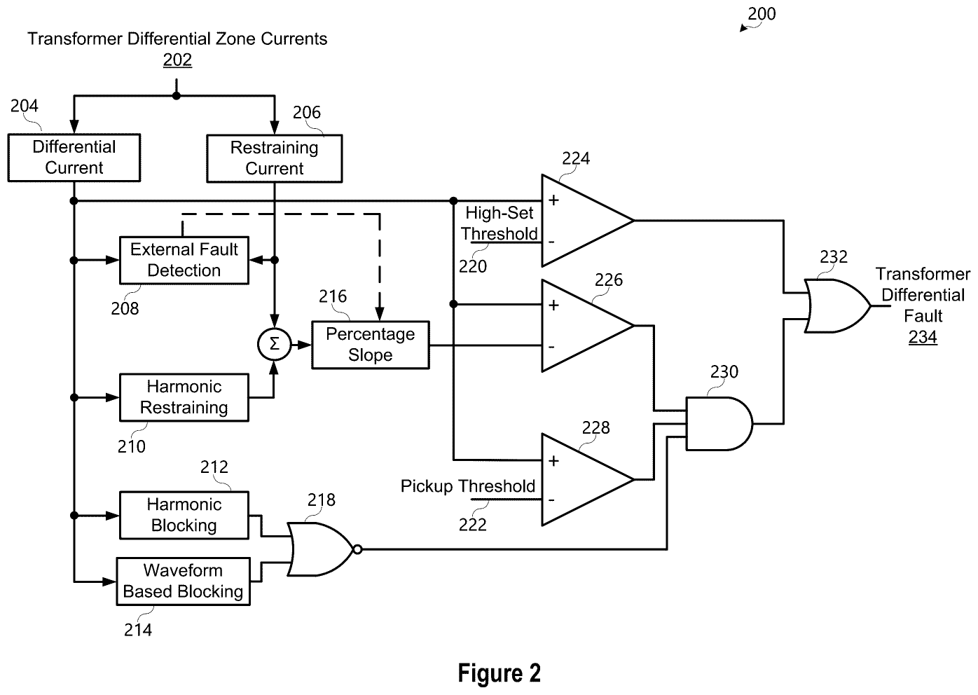

As mentioned above, the monitoring and protection module 138 may include instructions for applying transformer differential protection using signals from the power system 10. FIG. 2 illustrates a simplified logic diagram of a transformer differential protection element 200. The element 200 obtains transformer differential zone currents 202 such as currents at the terminals on each side of the transformer. The element 200 derives the differential (operating) 204 and restraining 206 currents by using all currents that form the boundary of the transformer differential zone. In dual-breaker applications with breaker bushing CTs, currents from both breakers should contribute to the restraining current. The transformer differential protection may be implemented as a three-phase (“phase-segregated”) element, or it may include a negative-sequence differential element. As discussed hereinafter, the term phase-segregated is not strictly correct because the transformer differential current equations mix currents from two or all three phases. In various embodiments described herein, transformer differential “loops” may be used rather than power system “phases” (similar to a distance protection element).

The differential element 200 operates (asserts a transformer differential fault signal 234) if the differential current 204 is above (comparator 228) the minimum pickup threshold 222 and (gate 230) above (comparator 226) a percentage 216 of the restraining current 206. These two comparators 226, 228 can be implemented on waveform samples (lowpass-filtered) or the fundamental-frequency phasor (bandpass-filtered) quantities.

The harmonic-blocking module 212 ensures security during magnetizing inrush and overexcitation conditions. If the differential current 204 is rich in harmonics, the logic blocks (gate 218). Even harmonics (primarily the second harmonic) indicate inrush. Odd harmonics (primarily the fifth harmonic) indicate stationary overexcitation. Harmonic blocking is preferably performed on a per-loop basis to avoid jeopardizing the differential element dependability. In certain applications, the level of harmonics during inrush conditions can be low. This forces protection engineers to 1) lower the harmonic blocking thresholds (i.e., make the harmonic blocking logic more sensitive to harmonic content) and risk affecting protection speed and dependability, 2) apply “cross-phase” (cross-loop) harmonic blocking with even more concerns about speed and dependability, or 3) use additional methods to address magnetizing inrush, such as waveform-based inrush detection 214.

Harmonic restraining 210, like harmonic blocking 212, is also based on high harmonic content in the differential current during inrush. However, instead of blocking the differential logic, harmonic restraining 210 uses harmonics in the differential current 204 to boost the restraining current 206 (e.g. via adding the harmonics to the restraining current). The gain factor between the differential harmonics added to the restraining current and the restraining current is selected in such a way that during the initial energization inrush, which is a single-end feed, the increase in the restraining current is sufficient—given the percentage slope setting—to prevent the differential element from operating. Harmonic restraining 210 and harmonic blocking 212 face similar issues in applications with low harmonic content during inrush. Typically, either harmonic blocking 212 or harmonic restraining 210 is used.

Both harmonic blocking 212 and restraining 210 slow down the differential logic 200. During internal fault conditions, the harmonic filters are excited with a sudden change in current and, as a result, they output spurious harmonics. For example, when using a full-cycle filter, a spurious harmonic signal lasts for one cycle before the filter correctly outputs zero as the value of that harmonic. Moreover, during inrush conditions, the harmonic filter is also subjected to the sudden change in current, and therefore it may temporarily underestimate the harmonic or the harmonic ratio. A harmonic ratio that momentarily falls below the blocking threshold would result in differential element misoperation. Therefore, practical differential element implementations add a dropout security timer in the harmonic blocking logic: if the harmonic ratio is above the blocking threshold for a certain time, such as a quarter cycle, a short dropout timer is engaged to ride through the temporary low harmonic content due to the transient response of the filters. This additional dropout timer further delays the unblocking action during internal fault conditions. As a result, the differential comparator 226 may be ready to operate for an internal fault in a quarter cycle, yet the harmonic blocking or restraining unit holds it back for more than a full cycle.

The unrestrained differential element remedies this situation but only for high-current internal faults. The unrestrained element uses a high-set threshold 220 instead of using the percentage restraint. The threshold 220 is set above the highest possible inrush current, removing the need to use harmonics for security during inrush conditions. When the differential current 204 exceeds (comparator 224) the high-set threshold 220, the element asserts a transformer differential fault signal (gate 234). In various implementations, the differential fault signal 234 may be asserted if the differential current exceeds the high-set threshold 220 or 232 when the differential current 204 both exceeds (comparator 228) the pickup threshold 222 and (gate 230) exceeds (comparator 226) a function 216 of the restraining current 206.

Waveform-recognition 214 addresses inrush typically by detecting the presence of dwell-time intervals in the differential current 204. These dwell-time intervals are present during inrush conditions but not during internal faults. However, the first dwell-time interval is visible in the inrush current only at the end of the first power cycle following energization. Therefore, a waveform-recognition module 214 must block 218 the differential element for just over one cycle, similarly to the harmonic-based methods. The waveform-recognition blocking 214 is not used for speed but to address the security concern related to the low second-harmonic content during energization.

The relatively slow differential element 200 operation may inadvertently impact dependability. To ensure the differential element operates for internal faults, the CT secondary currents must faithfully represent the primary currents without adding distortions that may cause the harmonic blocking 212 to assert and block 218 the differential element. As a result, the differential protection CTs must be rated to provide saturation-free operation for as long as it takes the differential element to operate. The worst-case scenario is when the differential element is initially blocked by spurious harmonics because of the filter transients and continues to be blocked because of actual harmonics arising from CT saturation.

The external fault detection logic 208 monitors the rise in the differential 204 and restraining 206 currents. During external faults, the restraining current 206 increases immediately while the differential current 204—if it increases because of CT saturation—increases after a time delay because the CTs initially operate without saturation. During internal faults, the differential 204 and restraining 206 currents increase together. Some external fault detection 208 implementations may also monitor the decaying DC components in the measured currents and operate in anticipation of CT saturation because of the large and slowly decaying dc component rather than the large AC component in the fault current. Typically, the external fault detection logic 208 engages a higher percentage slope in order to provide more restraint. The external fault detection logic 208 does not block the differential element, so the element continues to provide some protection should an internal fault develop during, and as a result of, the external fault.

An EFD logic 208 in accordance with several embodiments herein may use instantaneous differential current and instantaneous restraining current. The logic 208 may respond to changes (A) in the instantaneous differential and restraining currents respective to their one-cycle old values (Δi_{DIF} and Δi_{RST}). A change in restraining signal Δi_{RST} may be verified by comparison of Δi_{RST} with a predetermined threshold such as 1.5 per unit (1.5 times the transformer nominal current). The logic 208 may verify that the differential current remains small, such as less than a percentage restraint when using the lower slope of the restraining characteristic. If the restraining current changed but the differential current did not follow within a predetermined time period (e.g. 3 ms), then the logic asserts an external fault signal. Thus, the differential current and restraining current (or changes in the differential current and changes in the restraining current) are compared to determine an external fault condition. If an external fault condition is determined, then the transformer differential protection will remain secure even if CTs saturate during the fault.

Concerns related to voltage recovery inrush, sudden voltage change inrush, and sympathetic inrush prevented practitioners from applying very sensitive differential pickup thresholds. Concerns with CT ratio errors, transformer ratio tolerance, and onload tap changers drive higher slope settings. As a result, past differential elements were less sensitive than proposed herein.

Various transformer protection IEDs may include restricted earth fault (REF) protection elements. REF protection may follow a phase-comparison principle, a differential restraining principle, or a combination of the two.

The phase-comparison implementation treats the REF element as a ground directional element in which the neutral current (I_{N}) is the operating signal and zero-sequence current (310) is the polarizing signal. These two signals are out of phase during external faults and approximately in phase during internal faults. The phase comparison implementation verifies that the neutral-point current (I_{N}) is above the minimum pickup threshold (I_{NP}) before allowing the REF element to operate.

The differential REF implementation derives the differential (operating) current as the sum of the neutral-point current (I_{N}) and the 310 in the phase currents (I_{A}, I_{B}, and I_{C}) of the protected winding. Strictly speaking, REF protection is a four-current differential element, but often it is implemented and analyzed as a two-current differential element (I_{N} and 310) when used as a low-impedance scheme. The REF logic verifies that the differential current is above a minimum pickup threshold (REFP), but it should also verify that the neutral-point current (I_{N}) is above a minimum pickup threshold (INP).

Requiring I_{N} to be above a minimum pickup threshold contributes to REF security during phase-to-phase and balanced three-phase external faults with CT saturation. Practical implementations must also address security during external phase-to-phase-to-ground faults with CT saturation.

The differential restraining implementation derives a restraining current from the I_{N} and 310 currents. To address phase-to-phase and three-phase balanced faults, this implementation may also derive additional restraint from the phase currents or the positive- or negative-sequence current components.

Because the zero-sequence current is both a phasor and time domain signal, REF protection can be implemented by using instantaneous signals: i_{A}, i_{B}, i_{C}, and i_{N}.

The REF element is not affected by magnetizing inrush or overexcitation. Therefore, it can be faster than previous transformer differential elements. The REF element is not affected by the onload tap changer. Therefore, it can be more sensitive than previous transformer differential elements. Of course, the REF elements only detect faults that involve ground (core or tank) in grounded windings of the transformer.

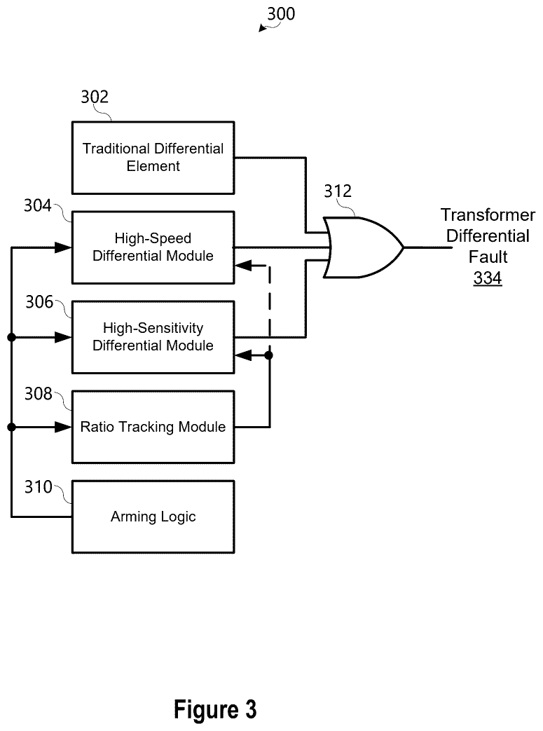

FIG. 3 illustrates a simplified logic diagram for transformer differential protection 300 used in an IED in accordance with several embodiments herein for improving speed and sensitivity. While traditional transformer differential protection 302 is retained, additional modules for high-speed differential protection 304 and high-sensitivity differential protection 306 are added to address speed and sensitivity independently. In addition, a module for transformer ratio tracking 308 may be used to inform the high-speed module 304 and the high-sensitivity module. Further, an arming logic module 310 may be used to oversee several of the protection modules. A transformer differential fault signal 334 is asserted when any 312 of the traditional differential element 302, high-speed differential module 304, or high-sensitivity differential module 306 assert,

The traditional differential protection element 302 provides the base performance (dependability, speed, and security). Retaining the traditional differential protection element 302 may reduce the implementation risks and aid in adoption of the improved modules described herein. The traditional differential protection element 302 provides an entry point for commonly used and well-understood settings. The new functional modules 304, 306, and 310 aimed at speed and sensitivity and supervision use these settings directly or derive their operating thresholds based on these settings.

The high-speed differential protection module 304 is designed and optimized for speed while maintaining security. Not having to be perfectly dependable, this module 304 can be kept simple and can achieve fast operation under typical conditions while disregarding difficult internal fault cases. To achieve fast operation, the high-speed differential protection module 304 uses current samples rather than phasors (i.e. i_{A}, i_{B}, i_{C}). Furthermore, this module may not use harmonics in the differential current to address the magnetizing current security challenges.

The high-sensitivity differential protection module 306 is designed and optimized for sensitivity while maintaining security. Not having to be perfectly dependable or fast, module 306 can be kept simple and can achieve sensitive operation under typical conditions while disregarding difficult internal fault cases. The high-sensitivity module 306 applies transformer ratio-tracking 308 to minimize the standing differential current (the high-speed differential protection module 304 can optionally use the online estimated ratio as well). The high-sensitivity module 306 uses a novel restraining signal.

Security of all two modules 304, 306 may be supervised by an arming logic 310. This arming logic 310 is a method for maintaining security by explicitly allowing the supervised logic 304, 306 to operate only under the conditions considered when designing that supervised logic. The arming conditions for the high-speed differential protection module 302 and the high-sensitivity differential protection module 304 may be different. The arming logic 310 also supervises the transformer ratio-tracking algorithm 308 to ensure that internal faults or inrush conditions do not lead to an incorrect estimation of the transformer ratio.

As will be described in more detail below, the differential modules in accordance with several embodiments herein use compensated winding currents for the transformer differential loops. Transformer differential current is based on an ampere-turn balance between pairs of core legs. Following this rule, the proper transformer winding compensation must be made based on the transformer configuration. For example, wye-type compensation must be used for, and only for, delta-connected windings; single-delta compensation must be used for, and only for, wye-connected windings; and double-delta compensation must be used for, and only for, zigzag-connected windings.

While the definition of transformer differential current is grounded in physics and is therefore unambiguous, the restraining current is design-driven and may take various forms.

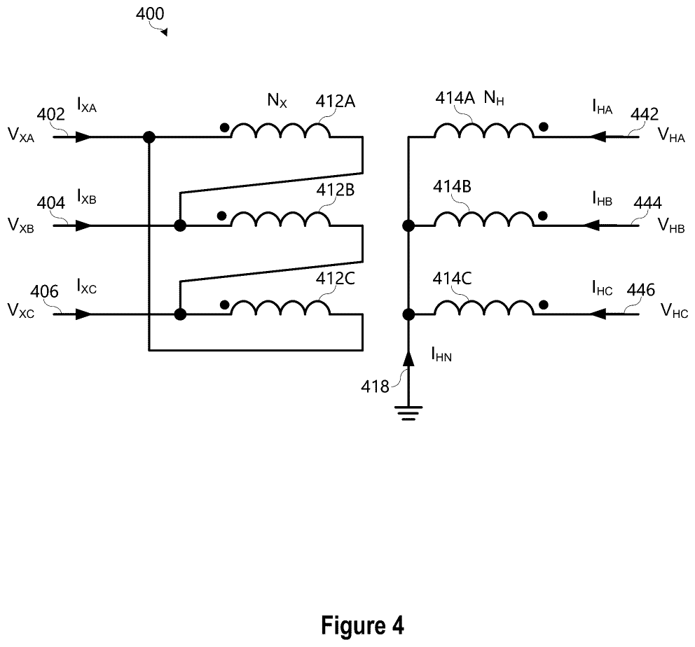

As an example, FIG. 4 illustrates a connection diagram 400 of a transformer in delta-wye (YNd1) configuration. The diagram illustrates connections of a transformer configured with a delta winding 412A-C on the X-side (low voltage, e.g. generation or distribution) and wye windings 414A-C on the H-side (high-voltage, e.g. transmission). The delta-side transformer A-phase 412A, B-phase 412B and C-phase windings 412C are in delta configuration, and are in electrical connection with the delta-side A-phase 402, B-phase 404 and C-phase 406 terminals, respectively. Wye-side A-phase 414A, B-phase 414B and C-phase windings 414C are in wye configuration, and in electrical communication with A-phase 442, B-phase 444, and C-phase 446 terminals. Further, the wye-side includes a neutral connection to ground 418. N_{X} (412A, 412B, 412C) is the number of delta-side winding turns, and NH (414A, 414B, 414C) is the number of wye-side winding turns. The figure also shows winding polarity by using dot symbols. In various embodiments, signals related to phase voltages and currents (V_{XA}, V_{XB}, V_{XC}, I_{XA}, I_{XB}, and I_{XC}) from the delta side of the transformer and from the wye side of the transformer (V_{HA}, V_{HB}, V_{HC}, I_{HA}, I_{HB}, and I_{HC}) and signals related to current on the neutral I_{HN} are available to the IED. Voltage and current signals may be obtained from various points in the system, as described in more detail below.

The ampere-turn balance in primary amperes between the top and bottom core legs in FIG. 4 is as follows in Equation 1:

N_{H}·(i_{HA}−i_{HC})+N_{X}·i_{XA}=0 Eq. 1

The nominal voltage ratio allows us to substitute for the turns ratio as follows in Equation 2:

$$\frac{{N}_{X}}{{N}_{H}} = \sqrt{3} \cdot \frac{{V}_{XNOM}}{{V}_{HNOM}} \qquad Eq . 2$$

where V_{XNOM} is the nominal line-to-line voltage on the X side, and V_{HNOM} is the nominal line-to-line voltage on the H side of the illustrated transformer.

Inserting Equation 2 into Equation 1 yields the following balance in Equation 3:

$$\frac{1}{\sqrt{3}} \cdot ( {i}_{HA} - {i}_{HC} ) + \frac{{V}_{XNOM}}{{V}_{HNOM}} \cdot {i}_{XA} = 0 \qquad Eq . 3$$

If the left-hand side expression differs from zero, it may signify an internal fault. Therefore, the left-hand side of Equation 3 may be used as a differential current (i_{DIF1}) as seen in Equation 4:

$${i}_{DIF 1} = \frac{1}{\sqrt{3}} \cdot ( {i}_{HA} - {i}_{HC} ) + K \cdot {i}_{XA} \qquad Eq . 4$$

where K is the transformer voltage ratio (also known as a “tap”).

Subscript 1 denotes the first loop of the differential current. Loops are used herein instead of “phases” because of mixed currents from two phases of the wye-connected winding. As expected, the delta-connected winding currents (subscript X) use wye-type compensation, and the wye-connected winding currents (subscript H) use single-delta compensation. The loop 2 and 3 differential currents may be obtained by rotating phase indices in Equation 4.

Differential current may be expressed in per unit of the transformer nominal current. Equation 4 is written in primary amperes on the H side. The H-side nominal current I_{HNOM} is:

$${I}_{HNOM} = \frac{{S}_{NOM}}{\sqrt{3} \cdot {V}_{HNOM}} \qquad Eq . 5$$

Dividing Equation 4 by Equation 5, the per-unit differential current may be obtained. However, Equation 4 may be used for convenience if the right-hand side currents are in per unit on the base as per Equation 5.

In prior implementations, users compensated for the transformer winding connections by connecting CT secondaries before supplying the compensated currents to an electromechanical differential relay. That electromechanical relay developed a restraining quantity i_{RST1} from the currents connected to it, following, for example, Equation 6 for the example transformer in FIG. 4:

$${i}_{RST 1} = \frac{1}{2} \cdot ( \frac{1}{\sqrt{3}} \cdot \vert {i}_{HA} - {i}_{HC} \vert + K \cdot \vert {i}_{XA} \vert ) \qquad Eq . 6$$

Instead of obtaining one restraining term from each of the three involved currents, Equation 6 may be used to derive a restraining term from the difference of two currents. In any other application, this approach would be referred to as partial restraint and considered not optimal. Microprocessor-based transformer differential relays never diverged from the traditional application of the transformer restraining current and continue to use Equation 6.

Restraining current as used herein may be redefined from traditional to follow the method of obtaining a separate restraining term from each of the currents that make up the differential current as illustrated for loop 1 in Equation 7:

$${i}_{RST 1} = \frac{1}{2} \cdot ( \frac{1}{\sqrt{3}} \cdot ( \vert {i}_{HA} \vert + \vert {i}_{HC} \vert ) + K \cdot \vert {i}_{XA} \vert ) \qquad Eq . 7$$

The new restraining current in Equation 7 provides better restraint than the traditional version in Equation 6. Consider the time instant at which i_{HA}=i_{HC}. Because the transformer is healthy, the differential current (Equation 4) is 0, and therefore i_{XA}=0 when i_{HA}=i_{HC}. As a result, the instantaneous restraining current (Equation 6) is zero at that point in time. Having a zero restraining current when the transformer carries current (i_{HA}≠0) is not preferred. When the new formula (Equation 7) is used, the instantaneous restraining current is 0.58·|i_{HA}| instead of 0.

Equation 7 applies to instantaneous values, and the | | symbol denotes an absolute value of a sample. When using Equation 7 with current magnitudes, additional scaling may be applied to Equation 7 with the intent to make Equation 7 identical to Equation 6 under balanced load conditions.

Equations 4 and 7, respectively, may be used as the instantaneous differential and restraining currents for the high-speed transformer differential module. The involved currents are in per unit on a transformer-rated current base, yielding per-unit differential and restraining currents. Table I summarizes the differential and restraining terms for the delta-, wye-, and zigzag-connected windings. The loop 2 and 3 currents are derived from the loop 1 currents by rotating phase indices.

TABLE 1
Differential and Restraining Currents

| Winding | | Differential | Restraining |
|---|---|---|---|
| Delta | Loop 1: | i_{A} | \|i_{A}\| |
| | Loop 2: | i_{B} | \|i_{B}\| |
| | Loop 3: | i_{C} | \|i_{C}\| |
| Wye | Loop 1: | $\frac{1}{\sqrt{3}} \cdot ( {i}_{A} - {i}_{C} )$ | $\frac{1}{\sqrt{3}} \cdot ( \vert {i}_{A} \vert + \vert {i}_{C} \vert )$ |
| | Loop 2: | $\frac{1}{\sqrt{3}} \cdot ( {i}_{B} - {i}_{A} )$ | $\frac{1}{\sqrt{3}} \cdot ( \vert {i}_{B} \vert + \vert {i}_{A} \vert )$ |
| | Loop 3: | $\frac{1}{\sqrt{3}} \cdot ( {i}_{C} - {i}_{B} )$ | $\frac{1}{\sqrt{3}} \cdot ( \vert {i}_{C} \vert + \vert {i}_{B} \vert )$ |
| Zigzag | Loop 1: | $\frac{1}{3} \cdot ( 2 \cdot {i}_{A} - {i}_{B} - {i}_{C} )$ | $\frac{1}{3} \cdot ( 2 \cdot \vert {i}_{A} \vert + \vert {i}_{B} \vert + \vert {i}_{C} \vert )$ |
| | Loop 2: | $\frac{1}{3} \cdot ( 2 \cdot {i}_{B} - {i}_{C} - {i}_{A} )$ | $\frac{1}{3} \cdot ( 2 \cdot \vert {i}_{B} \vert + \vert {i}_{C} \vert + \vert {i}_{A} \vert )$ |
| | Loop 3: | $\frac{1}{3} \cdot ( 2 \cdot {i}_{C} - {i}_{A} - {i}_{B} )$ | $\frac{1}{3} \cdot ( 2 \cdot \vert {i}_{C} \vert + \vert {i}_{A} \vert + \vert {i}_{B} \vert )$ |

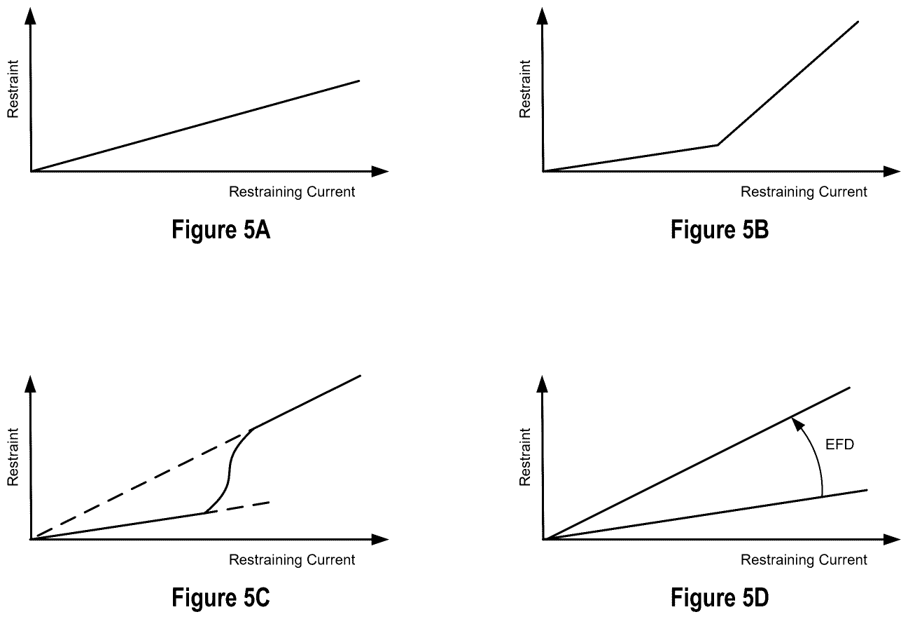

A current differential element may compare the differential and restraining signals using a differential operating characteristic. In previous implementations a current differential element developed a restraining current, multiplied it by a percentage slope to obtain an estimation of the spurious differential current, and used that estimate as a variable (adaptive) threshold to verify if the measured differential current is higher than the estimated spurious differential current. If so, the element operates. If not, the element restrains. The percentage slope operating characteristic can be a single-slope function (FIG. 5A), dual-slope function (FIG. 5B and FIG. 5C), or adjustable-slope function controlled by dedicated logic such as external fault detection logic (FIG. 5D).

The previous approach does not account for the fact that the currents that make up the differential protection zone can be at different levels with respect to the nominal currents of their CTs. Effectively, the previous approach to restraining uses an average current of all the CTs and estimates an average error caused by CT ratio inaccuracy and CT saturation. Additionally, when Equation 6 is used, the H-side Phase A and Phase C currents subtract, yielding a restraining term that poorly reflects the current levels with respect to the CT nominal currents.

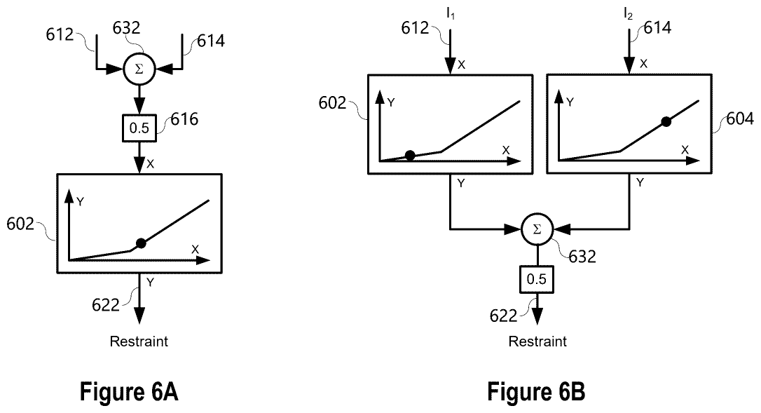

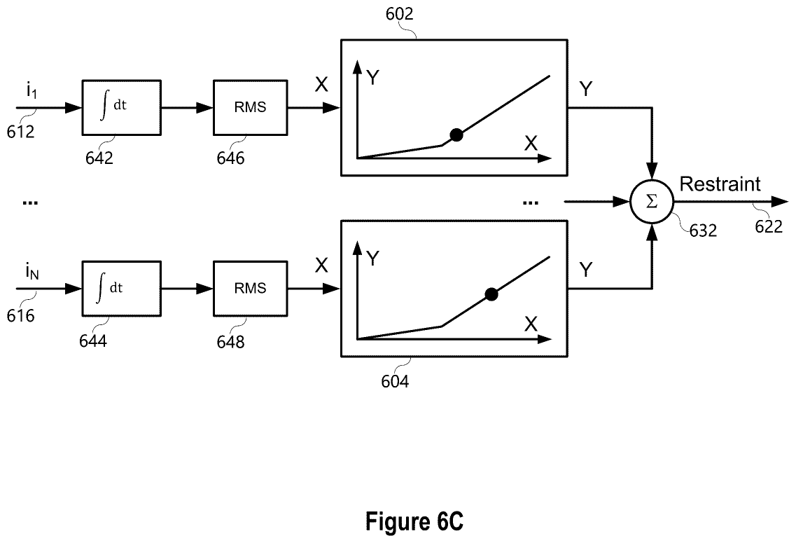

In accordance with several embodiments herein, sensitive differential protection is obtained using a separate restraint from each current that makes up the differential zone. These individual restraints are then summed. FIGS. 6A, 6B, and 6C provide illustrations of logic diagrams to further show the described improvement.

The previous approach is illustrated in FIG. 6A, where two currents 612 and 614 are averaged by summation 632 and division (or multiplication by a factor) 616, and then applied to the percentage slope function 602 to yield the restraint signal 622. In the percentage slope function 602, the restraining current axis and the slope characteristic breakpoint setting relate to the transformer per-unit current.

FIG. 6B illustrates an example of the improvement described herein, where the first CT current I₁ 612 is applied to a percentage slope function 602 to produce a first restraining factor; the second CT current I₂ 614 is applied to a percentage slope function 604 to produce a second restraining factor; and the outputs thereof are averaged (e.g. by summation 632 and division (or multiplication by a factor) 622), to yield the restraint signal 622. The restraining current axis and the breakpoint setting of the percentage slope function(s) 602, 604 relate to the CT per-unit current for the two CTs that supply the I₁ and I₂ currents. Because the restraining logic derives the restraint based on the current level relative to the CT nominal current, the slope and breakpoint settings do not have to be set and can be fixed by design based on the characteristics of a typical CT.

The method recognizes where each individual current is in relation to the CT nominal current and applies a higher restraint based on that specific information. Because this approach uses more information than previous approaches, it provides a more accurate estimation of the possible spurious differential current. This fact, in turn, allows increasing sensitivity of differential protection by lowering the slope values in, for example FIG. 6B as compared with FIG. 6A.

Another refinement described herein for the high-sensitivity transformer differential module is to derive the restraint from the integral of the secondary current rather than the secondary current. CT errors, including saturation errors, depend on the flux in the CT core, i.e., on the voltage across the CT magnetizing branch. This voltage may be approximated by the voltage drop from the secondary current that flows through the total CT burden resistance. Because the flux is the integral of the magnetizing voltage, the flux may be approximated by the integral of the secondary current. If the current integral can be scaled to have a gain of 1 at the nominal system frequency, the CT burden resistance may be disregarded and the integral of the secondary current may be used in place of the secondary current.

The current may be integrated using Equation 8:

i_{INT(k)}=A·(i_{INT(k-1)}+B·i₍ₖ₎) Eq. 8

where:

$$A = \frac{{f}_{S}}{{f}_{S} + \frac{1}{{T}_{D}}} and B = 2 π \cdot \frac{{f}_{N}}{{f}_{S}} \qquad Eq . 9$$

where k is a sample index, f_{S} and f_{N} are the sampling and nominal frequencies, respectively, and T_{D} is the design time constant that controls how long the integrator holds the DC component. The T_{D} constant may be on the order of around 0.25 s.

FIG. 6C illustrates a simplified logic diagram of the calculation of the restraint signal using the integration in Equations 8 and 9.

In the implementation shown in FIG. 6C, each current that makes up the differential zone (i₁ 612, I_{N} 616) contributes to the restraining current as shown in Table I. The logic integrates 642, 644 the instantaneous currents it 612, I_{N} 616 by using Equation 8 and obtains a replica of the instantaneous flux in the CT core. The logic then derives a one-cycle true root-mean-square (rms) value 646, 648 in order to apply the restraint to a phasor-based differential current. The rms value is applied to the dual-slope restraining function 602, 604 in per unit of the CT nominal current. The logic then sums the individual restraints 632 to yield the restraint signal 622.

The restraining characteristics 602, 604 can have a first slope setting as small as 2 percent and a breakpoint on the order of 3 times the CT nominal current. The second slope setting can be on the order of 20 percent.

The restraining method for the high-sensitivity transformer differential module has been shown to work very well when the current contains a decaying DC component. The calculated integral increases because of the DC component and produces a higher restraint compared with using the current phasor magnitude to obtain the restraint.

As illustrated in FIG. 3, a ratio tracking module 308 may be used to track transformer ratio and apply the ratio to the high-sensitivity differential module 306, and optionally, to the high-speed differential module. The restraining method described above accounts for CT and relay errors. To improve sensitivity, very small slope values should be applied in FIG. 6C. However, to do this securely, the transformer ratio must be accounted for accurately, especially if an onload tap changer is installed. The transformer ratio may be tracked as long as the transformer is healthy and is not being energized.

Consider the differential current in Equation 4, which is a sample case that is valid for a two-winding wye-delta transformer. It may be generalized for a multi-winding transformer with any combination of winding connections as follows in Equation 10:

i_{DIF}=K₁₁·i_{W1}+K₁₂·i_{W2}+ . . . +K_{1q}·i_{Wq} Eq. 10

where i_{Wn} denotes the compensated winding current of winding n (where n=1, . . . , q) according to Table 1 (wye, single-delta, or double-delta compensation), and K₁ₙ denotes the ratio-matching factor of winding n with respect to winding 1. The nominal values of the K₁ₙ coefficients are calculated from the nominal winding voltages.

Assume that p denotes the winding that has an onload tap changer installed. If there is no onload tap changer, select p to be the winding with the highest and most persistent current (supply side rather than load side). Equation 10 may be re-written as follows in Equation 11:

$${i}_{DIF} = {K}_{1 p} \cdot {i}_{Wp} + {{{\sum }_{k = 1}}_{k \neq p}}^{q} {K}_{1 k} \cdot {i}_{Wk} \qquad Eq . 11$$

In Equation 11, K₁ₚ may be treated as a variable, and the K₁ₖ scaling coefficients may be assumed to remain at their nominal values. The objective is to find a value for K₁ₚ that minimizes the standing differential current. The total current of all the windings other than p may be treated as a single equivalent current as in Equation 12:

$${i}_{EQ} = {{{\sum }_{k = 1}}_{k \neq p}}^{q} {K}_{1 k} \cdot {i}_{Wk} \qquad Eq . 12$$

The differential current may be expressed as in Equation 13:

i_{DIF}=K₁ₚ·i_{Wp}+i_{EQ} Eq. 13

The least squares method may be used to seek a value for Kip that minimizes the differential current given the measured currents, as shown in Equation 14:

$${\sum }_{T} {( {K}_{1 p} \cdot {i}_{Wp} + {i}_{EQ} )}^{2} \to minimum \qquad Eq . 14$$

The time window length T does not need to be a multiple of power cycles and can be as long as a fraction of a second, such as 200 ms.

Solution of the least squares of Equation 14 yields Equation 15:

$${K}_{1 p} = - \frac{{\sum }_{T} {i}_{EQ} \cdot {i}_{Wp}}{{\sum }_{T} {i}_{Wp}^{2}} \qquad Eq . 15$$

Equation 15 involves calculating two sums of sample-by-sample current products over the time interval T. The calculation could be supervised by the arming logic such as by not allowing to track the ratio during inrush conditions. The ratio-matching coefficient K₁ₚ must be clipped at the expected range limits, such as at (1+R) per unit, where R is the per-unit regulation interval. For example, with R=0.1 (10 percent onload tap changer regulation), the expected values of the per-unit ratio-matching coefficient are between 0.9 and 1.1.

Magnetizing current appears as a spurious differential current. The high-sensitivity transformer differential module uses a traditional harmonic-based approach to inrush and overexcitation. To operate fast, the high-speed transformer differential module must use a different approach. The following addresses several magnetizing current situations.

### Initial Energization Inrush.

The high-speed transformer differential module rules out the initial energization inrush as a source of the differential current based on the presence of voltage at and load current in any of the transformer windings.

Because a transformer carrying load current is already energized, it cannot be subject to initial energization. The magnitudes of the compensated winding currents as shown in Table I may be used to detect load. If the magnitude of any of the compensated winding currents is above a certain threshold, on the order of 10 percent of the winding nominal current, the logic may declare the transformer energized. Using the compensated winding currents and not the restraining current avoids false operation of the logic if a winding that is terminated on two breakers is de-energized through an open disconnect switch.

It is also true that the transformer is already energized when voltage is present at least one of the windings.

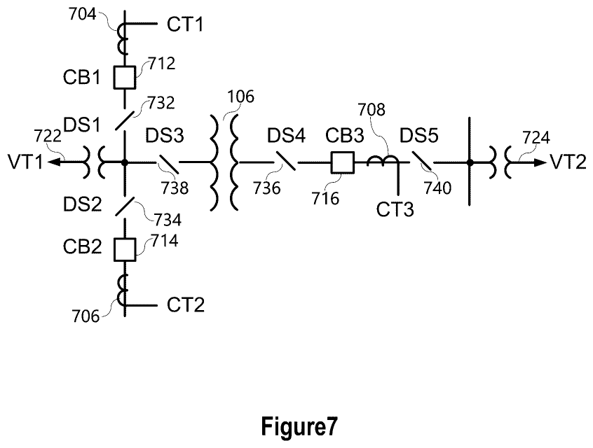

FIG. 7 shows a simplified one-line diagram of an application example. The sum of the CT1 704 and CT2 706 currents is the winding current of the transformer 106. If the DS3 738 disconnect switch is open but the circuit breaker (CB) CB1 712 and CB2 706 breakers and the corresponding disconnect switches 732 and 734 are closed and the CB1-CB2 712-714 path carries current, the winding current is still zero and the protection device does not declare the transformer energized based on the CT1 712 and CT2 714 load currents. If the relay has access to the voltage transformer VT1 722 voltage, it supervises the use of this voltage with the closed position of the DS3 738 disconnect switch before declaring the transformer 106 energized. If the protective device has access to the VT2 724 voltage, it supervises the use of this voltage with the closed positions of the DS4 736 and DS5 740 disconnect switches and the CB3 716 breaker. For better security, it is good practice to use a dual-point monitoring of the disconnect switches.

Supervision with the disconnect and breaker status signals may be necessary only when using bus-connected VTs and not when using VTs connected directly to the transformer terminals. Accordingly, in several embodiments voltage and/or current signals may be obtained at or nearer to the transformer terminals, such as CT3 708.

In various embodiments, the transformer may be determined as energized (and, thus, the differential protection is allowed to operate) when the magnitude of any of the compensated winding currents is above the threshold OR voltage is present in at least one of the windings. In some embodiments, the transformer may be determined as energized (and, thus, the differential protection is allowed to operate) when the magnitude of any of the compensated winding currents is above the threshold AND voltage is present in at least one of the windings.

### Voltage Recovery Inrush.

Voltage recovery inrush occurs when a close-in external fault is cleared. The fault depresses the transformer voltage. When the fault is cleared and the voltage suddenly returns to the normal value, the transformer is subject to a form of “partial re-energization”. Voltage recovery inrush may be addressed as follows. First, the external fault detection logic triggers for the external fault as long as the system is not extremely weak. The external fault detection logic blocks the high-speed transformer differential module for the duration of the fault and for some time after the fault is cleared. Second, the voltage decreases during the external fault and disarms the high-speed transformer differential module. The voltage may remain high if the system is extremely strong. In such a case, the external fault detection logic is guaranteed to assert. A third method uses arming logic. The external fault causes changes in voltages, currents, or both. The arming logic allows the transients (changes) in the currents and voltages associated with the inception of the external fault to disarm the high-speed transformer differential module before the fault is cleared and the return of voltage to its normal value causes an inrush current. Once disarmed, the module re-arms only after the recovery inrush current dissipates.

### Sympathetic Inrush.

During sympathetic inrush, magnetizing current increases gradually over several power cycles. It starts with the excitation current on the order of 1 to 2 percent of the transformer nominal current and rises to the level consistent with a magnetizing inrush on the order of several times the transformer nominal current.

When a transformer parallel to the protected transformer is energized, it starts to draw significant unipolar inrush current. This unipolar current creates a unipolar voltage drop across the equivalent system resistance. This in turn results in a DC offset in the voltage at the terminals of the protected transformer. This voltage offset persists for the duration of the inrush of the transformer being energized, and it ratchets up the flux in the protected transformer. However, it takes some time for the flux to shift away from the average of zero and into the area that causes the magnetizing branch to draw higher magnetizing currents. This is the reason for the gradual increase of the sympathetic inrush current. It often takes several cycles for the sympathetic inrush current to develop.

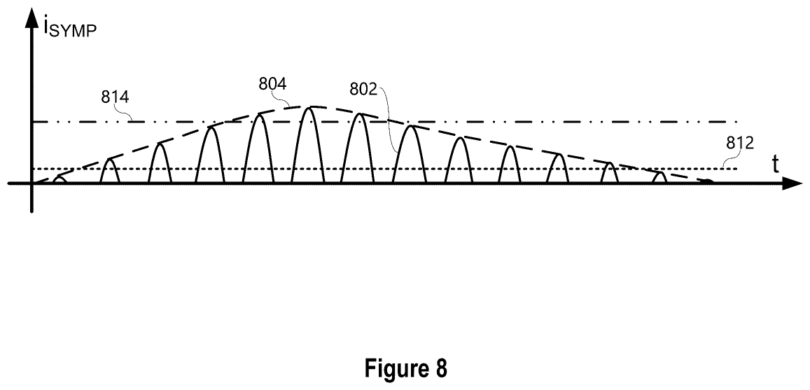

FIG. 8 illustrates a simplified plot of a differential current 802 and its envelope 804 over time during sympathetic inrush. The gradual increase in the spurious differential current can be used to detect sympathetic inrush and secure the high-speed differential module by requiring the differential current to transition above the pickup threshold relatively quickly.

Sympathetic inrush logic may use an auxiliary threshold 812 (in various embodiments, around one-fourth of the minimum pickup threshold to detect that the differential current 802 starts increasing. From that moment, the logic allows a short window, on the order of one-third of a power cycle, for the differential current 802 to continue increasing in the same direction (positive or negative) and to cross the minimum pickup threshold 814. If the differential current 802 increases within the time window, the high-speed transformer differential module is allowed to operate. If it does not, the sympathetic inrush logic disarms the high-speed transformer differential module.

### Sudden Voltage Change Inrush.

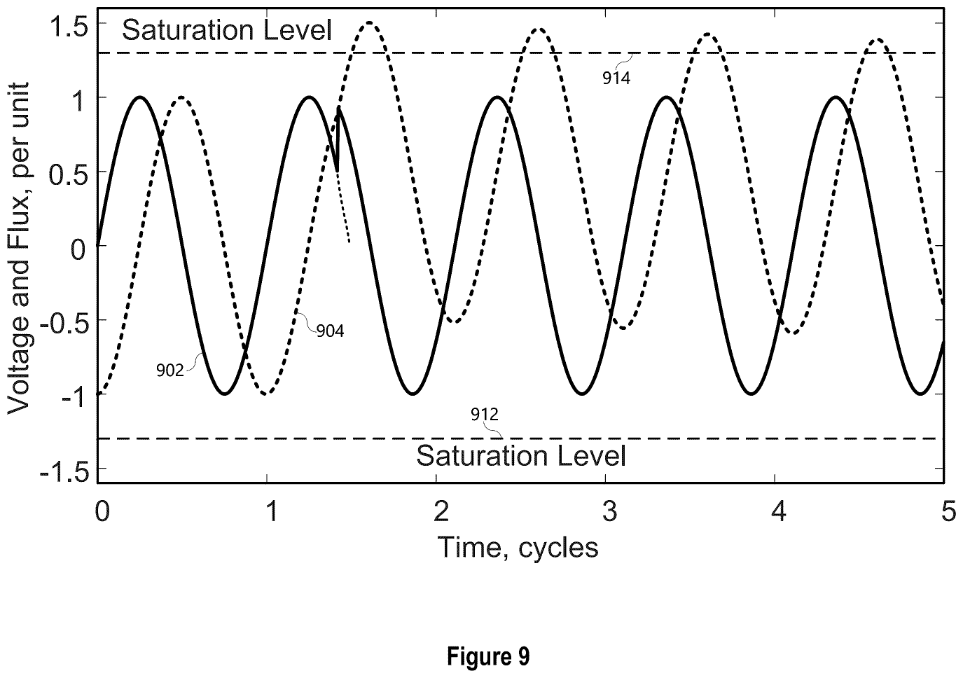

A sudden change in voltage at the transformer terminals may elevate the flux and cause the transformer to draw an inrush like current. Consider a switching scenario that does not involve an increase in voltage magnitude but only a small shift in the voltage angle. FIG. 9 illustrates a plot of voltage 902 and flux 904 during sudden voltage change inrush. Because switching in the system may delay the voltage zero crossing, the voltage integral (the area under the voltage curve) grows. The increasing voltage integral means that the flux 904 increases potentially up to the saturation region 914 (if positive) or 912 (if negative) of the core and causes an inrush-like current to flow. Note that the flux 904 developed an offset as a result of the switching operation. This offset eventually decays, but the process takes a relatively long time (similar time constant to that of the initial energization inrush).

Switching events that change voltage 902 (disconnecting loads, capacitor banks, or reactors) can increase the flux 902 and may cause an inrush-like current. Like the initial inrush current, this magnetizing current eventually decays to the excitation current level that is consistent with the steady-state values of voltage and frequency. If the steady-state voltage magnitude is high, the excitation current may increase well above 1 to 2 percent of the nominal transformer current. However, before the current settles on the excitation level, it may resemble an inrush current even if the voltage magnitude does not increase.

Security of the high-speed transformer differential module may be secured by using transformer voltage. The sudden voltage change logic integrates the voltage to obtain flux by using an approach analogous to Equation 8, as shown in Equation 16:

Flux₍ₖ₎=A·(Flux₍ₖ₋₁₎+B·vf₍ₖ₎) Eq. 16

where A and B are coefficients defined in Equation 9.

For simplicity, the gain (scale) in Equation 16 is 1 Wb/V. This way, a voltage threshold can be directly applied to the flux obtained by using Equation 16. The logic compares the flux with a threshold, such as the flux value for 115 percent of the nominal voltage, to detect an imminent inrush current.

In accordance with several embodiments, the flux is determined using phase-to-ground voltages for solidly grounded wye-connected windings; phase-to-phase voltages for delta-connected windings; and phase-to-ground voltages minus the voltage drop from the neutral current across the grounding impedance for impedance-grounded wye-connected windings.

In various embodiments, the high-speed differential module may be inhibited when either of the two legs in the differential loop is over-fluxed. For example, considering the transformer of FIG. 4, the differential current (Equation 4) balances ampere-turns between the top and bottom legs. Therefore, the logic blocks the differential loop for the following conditions: if either the v_{AB} Or v_{CA} voltages on the delta-side yield elevated flux values; if either the v_{A} or v_{C} voltages on the wye-side yield elevated flux values.

The following mapping rule may be applied between the measured currents that make up the differential current and the terminal voltages used to derive the flux and block the high-speed transformer differential module. If using voltages from the wye-connected side, use the same phases as in the differential current (v_{HA} and v_{HC}, because i_{HA} and i_{HC} appear in Equation 4). If using voltages from the delta-connected side, use the phase-to-phase voltages that involve the same phases as in the differential current (v_{XAB} and v_{XCA}, because i_{XA} appears in Equation 4).

The above rule makes the implementation straightforward: the phase indices of the measured currents that make up the differential current also define the voltages that must be used to supervise the high-speed transformer differential module on a per-loop basis.

In various embodiments, the voltage drop across the transformer may be resolved using one or more of the following. The voltage may be measured at the transformer terminal with the highest per-unit voltage (supply side). Voltage at any winding may be used to block the high-speed transformer differential module (with all voltages connected to the relay). The currents may be used to compensate for the voltage drop across the transformer to derive voltages at all terminals and voltage at any winding may be used to block the high-speed transformer differential module.

Furthermore, the element may treat ground faults using the following. Consider an internal AG (A-phase-to-ground) fault on the wye-connected side of the transformer in FIG. 4. If the B and C phase voltages increase, the transformer can draw magnetizing currents in the B and C phases on the wye-connected side. The i_{HB} and i_{HC} currents are involved in all three transformer differential loops. The inrush current may increase harmonic content in the differential current and therefore jeopardize the transformer differential element dependability. Typically, the fault current is large, making the harmonics relatively small, which results in dependable transformer differential element operation. However, this scenario is one of the reasons to avoid cross-phase harmonic blocking.

In the context of the high-speed transformer differential module, if an internal fault elevates the B or C phase voltages, they may inadvertently block the high-speed transformer differential module in all three loops. This may be resolved by monitoring the sequence of events. During internal faults, the differential current increases first and the flux associated with the healthy phases increases to reach the saturation level a few milliseconds later. During switching events that lead to overfluxing, the flux increases first and the differential current follows. This sequence pattern is similar to the pattern the external fault detection logic uses when it monitors the sequence between the differential and restraining currents. Accordingly, a differential element may be blocked when the flux increases first and the differential current follows after a certain time delay on the order of as fraction of power cycle.

### Stationary Overexcitation.

Stationary overexcitation is not a threat to the high-speed transformer differential module because the arming logic does not arm the high-speed transformer differential module if there is a standing differential current, such as the stationary overexcitation current. If the stationary overexcitation condition begins suddenly, the sudden voltage change logic ensures security in the initial few cycles and the arming logic disarms the element afterward.

As mentioned above, arming logic (310, FIG. 3) may be used to supervise the high-speed differential module 304 and/or the high-sensitivity differential module 306. The purpose of arming logic is to allow the supervised protection logic to engage only when conditions are satisfactory. More specifically, the arming logic monitors if the transformer conditions are among those that have been considered during the design stage of the supervised logic. By doing so, the arming logic ensures security by inhibiting the supervised logic during conditions that have not been explicitly considered and tested during the design stage. This approach to security yields excellent results in practical applications of ultra-high-speed protection principles.

The high-speed transformer differential module is armed when certain conditions occur. In various embodiments, a set of these conditions must be met, whereas in other embodiments, all of these conditions must be met. The conditions include: the transformer winding currents and voltages indicate that the transformer is already energized; the standing differential current is small, signifying the transformer is not drawing an inrush current or experiencing a differential current caused by CT problems, tap changer operation, or CT saturation during external faults; the transformer voltage and frequency are within the normal operating limits (or a flux calculated using voltage and frequency is within the normal operating limits); the winding currents are in a steady state; and, the external fault detection (EFD) logic is reset, signifying no external fault is present or was present in the recent past.

When armed, the high-speed transformer differential module may remain armed for a predetermined period of time following a disturbance. In various embodiments, the period of time may be on the order of one cycle. The high-speed transformer differential module provides accelerated tripping. Therefore, keeping it engaged for a longer period following a disturbance has no benefits-only potential disadvantages.

If the arming logic detects one or more arming conditions when the high-speed transformer differential module operating time window is open, the window immediately closes. The arming conditions include, for example: sympathetic inrush based on the slow rise in the differential current; overexcitation based on the calculated flux; and an external fault based on the assertion of the EFD logic.

Once the arming logic opens and closes the operating time window, it may apply an intentional time-out delay (it disables itself) on the order of 1 s before it verifies the arming conditions and arms again if the conditions allow.

The high-sensitivity transformer differential module may be armed using the same basic conditions as the high-speed transformer differential module. Additionally, the arming logic may require the transformer ratio-tracking module to settle following a tap changer operation. Also, the operating time window is longer to account for the filtering and additional security time delay of the high-sensitivity transformer differential module.

The embodiments herein may be used to provide differential protection to a transformer during transformer energization. A transformer fault during energization is likely if the root cause of the fault is a buildup of moisture or other contaminants in the oil and paper insulation during the time the transformer was de-energized. When the voltage is applied, the compromised insulation holds for a period of time but finally fails.

In accordance with several embodiments, the incremental current may be used in bipolar overcurrent logic to determine a fault condition during energization of a transformer. Bipolar differential logic operates if the differential current falls below a negative threshold shortly after crossing a positive threshold or vice versa. This approach is insensitive to inrush because the inrush current, if large, is unipolar.

During the first cycle of inrush, the incremental differential current (Δi_{DIF}) is the same as the inrush current (i_{DIF}) because the incremental current is obtained by subtracting zeros. However, the CTs do not saturate that quickly on inrush and the incremental current is decisively unipolar in the first few cycles of inrush. The CTs may saturate later, but at that time, the incremental current is very small because the inrush current is periodic. When the fault occurs, the incremental current reflects the fault current and gives the bipolar overcurrent logic a chance to operate (the incremental current crosses the positive and negative thresholds in quick succession).

Thus, according to several embodiments, the transformer differential element calculates incremental differential current during energization of the transformer. If the incremental differential current exceeds a predetermined positive threshold and then falls below a predetermined negative threshold within a set time (or vice versa), then an internal fault is declared. The IED may then effect a protective action by, for example, opening circuit breakers to the transformer.

For better security, this incremental bipolar overcurrent logic in the transformer differential protection element and the incremental current-based REF logic can be supervised (armed). The arming logic should enable them only when they are beneficial and when the conditions allow.

The embodiments herein may be used to provide differential protection to a transformer when energizing a faulted transformer. This scenario is likely if the root cause of the fault is a permanent fault that developed during the time the transformer was de-energized. Examples include safety grounds inadvertently left after working on the protected transformer and debris, animals, or other foreign objects making their way to the bushings or breaker connections while the transformer was de-energized.

When the transformer is being energized, a short time lag occurs between the moment the voltage is applied and when the inrush current starts to flow. This delay is on the order of 2 to 4 ms and is related to the time it takes the flux to build up and reach the saturation level. Transformer energization starts with dwell times between the adjacent peaks of the current during typical transformer inrush conditions.

When the transformer is faulty, the fault current rises immediately after the voltage is applied. The IED can apply a current derivative to distinguish between the steep rise of the differential current during a fault and the more gradual rise of the current during energization.

Additionally, when using high sampling rates, a transformer relay can determine the exact moment voltage is applied to the transformer by detecting small-magnitude but very high-frequency components (on the order of hundreds of kilohertz) in the winding currents, caused by charging the winding stray capacitances. These high-frequency components can be used as a time marker. If the differential current starts building up immediately, then there is an internal fault. If the differential current stays small for about 2 ms, then the subsequent rise in the differential current can be attributed to transformer energization. The relay can also use the voltage signal to determine the energization moment, assuming the voltage transformers are of relatively high fidelity (when using magnetic VTs instead of CCVTs) and are installed on the transformer side of the energizing breaker.

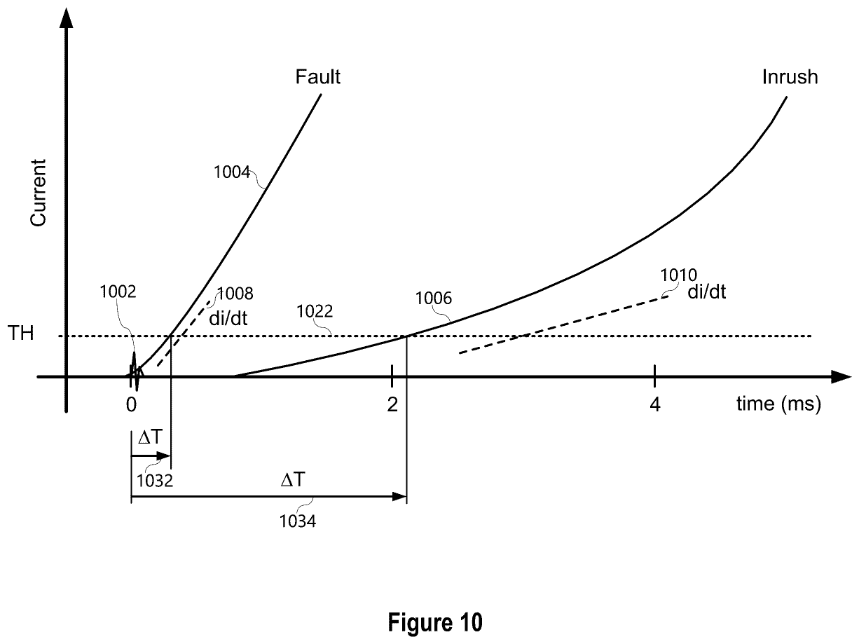

FIG. 10 illustrates a simplified plot of current during energization on a faulted transformer 1004 and current during energization of a non-faulted transformer 1006 showing typical inrush conditions. The appearance of the high-frequency current component 1002 sets the time mark to zero. The fault current 1004 crosses a threshold 1022 after a short time ΔT 1032. For inrush, the current 1006 crosses the threshold 1022 after a longer time 1034. Further, a time derivative (di/dt) 1008 taken at the time the faulted current 1004 crosses the threshold 1022 is higher than the time derivative 1010 taken at the time that the non-faulted current 1006 crosses the threshold 1002. This principle can be used in both the transformer differential protection element to improve dependability when energizing a transformer with a pre-existing fault.

Accordingly, a transformer differential module in accordance with several embodiments herein may obtain current signals during energization of a transformer and detect a high-frequency current to determine a time that the voltage is applied to the transformer. The module may start a timer to determine a time from the detection of the high-frequency current to the time that the current exceeds a predetermined energization threshold. When the current exceeds the threshold in less than a predetermined time, then the element may declare a fault condition and effect a protective action.

In several embodiments, the transformer differential module may obtain current signals during startup and determine a time derivative (di/dt) at the time that the current crosses the predetermined energization threshold. If the time derivative exceeds a predetermined threshold, then the element may declare a fault condition and effect a protective action.

While specific embodiments and applications of the disclosure have been illustrated and described, it is to be understood that the disclosure is not limited to the precise configurations and components disclosed herein. Moreover, principles described herein may also be used for primary distance protection, and other protective functions where a break in the zero-sequence network is introduced by electric power system equipment. Accordingly, many changes may be made to the details of the above-described embodiments without departing from the underlying principles of this disclosure. The scope of the present invention should, therefore be determined only by the following claims.

What is claimed:

1. A transformer protection device comprising:
a signal acquisition subsystem to obtain current and voltage signals for each winding terminal of a transformer in an electric power delivery system;
a protection module to:
calculate a plurality of compensated winding currents using the current signals from the signal acquisition subsystem based on a configuration of the transformer;
derive a differential signal as a sum of compensated winding currents;
derive a restraining signal as a combination of the transformer winding currents compensated for the winding connections;
determine presence of an external fault condition based on a comparison of the differential signal and the restraining signal;
determine that the differential signal is not due to transformer magnetizing inrush current;
determine that the differential signal is not due to transformer overexcitation currents;
assert a differential fault signal based on a comparison of the differential signal and the restraining signal using a differential operating characteristic;
effect a protective action upon assertion of the differential fault signal when an external fault determination is not determined.

2. The transformer protection device of claim 1, wherein:
each compensated winding current is integrated; and,
the integrated winding currents are combined to produce the restraining signal.

3. The transformer protection device of claim 1, wherein the restraining signal depends on a ratio between a winding current and a current transformer nominal current.

4. The transformer protection device of claim 1, wherein the differential signal is determined as not due to transformer magnetizing inrush current when any compensated winding current is above a predetermined winding current threshold.

5. The transformer protection device of claim 1, wherein the differential signal is determined as not due to transformer magnetizing inrush current when any voltage signal related to a winding of the transformer exceeds a predetermined threshold.

6. The transformer protection device of claim 1, wherein the differential signal is determined as not due to transformer magnetizing inrush current when a calculated flux corresponding with any winding terminal does not exceed a predetermined value.

7. The transformer protection device of claim 1, wherein the differential signal is determined as not due to transformer magnetizing inrush current when the differential current increases followed by an increase in flux in transformer winding terminals.

8. The transformer protection device of claim 1, wherein the differential signal is determined as not due to transformer overexcitation current when a calculated flux is within normal operating limits.

9. The transformer protection device of claim 1, wherein the protection module is further configured to monitor a transformer ratio using instantaneous current signals.

10. The transformer protection device of claim 1, wherein the transformer ratio is calculated as a ratio of sums of current products from the current signals over a predetermined time interval.

11. The transformer protection device of claim 1, wherein the differential fault signal is asserted during energization of the transformer when a time between an incremental current crossing both a predetermined positive threshold and a predetermined negative threshold is less than a time threshold, wherein the incremental current is calculated using the current signals.

12. The transformer protection device of claim 1, wherein the differential fault signal is asserted during energization of the transformer when the differential current exceeds a predetermined energization threshold within a predetermined time after energization is detected.

13. The transformer protection device of claim 12, wherein the energization is detected using a high-frequency current event.

14. The transformer protection device of claim 1, wherein the differential fault signal is asserted during energization of the transformer when a time derivative of the differential current taken when the current crosses a threshold exceeds a predetermined threshold.

15. A method for transformer differential protection, comprising:
acquiring current and voltage signals for each winding terminal of a transformer in an electric power delivery system using a signal acquisition subsystem of an intelligent electronic device;
calculating a plurality of compensated winding currents using the current signals from the signal acquisition subsystem based on a configuration of the transformer;
deriving a differential signal as a sum of compensated winding currents;
deriving a restraining signal as a combination of the transformer winding currents compensated for the winding connections;
determining presence of an external fault condition based on a comparison of the differential signal and the restraining signal;
determining that the differential signal is not due to transformer magnetizing inrush current;
determining that the differential signal is not due to transformer overexcitation currents;
asserting a differential fault signal based on a comparison of the differential signal and the restraining signal using a differential operating characteristic;
effecting a protective action upon assertion of the differential fault signal when an external fault determination is not determined.

16. The method of claim 15, further comprising:
integrating each compensated winding current; and,
combining the integrated winding currents to produce the restraining signal.

17. The method of claim 15, wherein the restraining signal depends on a ratio between a winding current and a current transformer nominal current.

18. The method of claim 15, wherein the differential fault signal is asserted during energization of the transformer when a time between an incremental current crossing both a predetermined positive threshold and a predetermined negative threshold is less than a time threshold, wherein the incremental current is calculated using the current signals.
